(19) United States
(12) Patent Application Publication
(10) Pub. No.: US 2008/0155591 A1
(43) Pub. Date: Jun. 26, 2008

(54) METHOD, SYSTEM AND DEVICE FOR PROVIDING ADVERTISEMENT CONTENT IN PLACE-SHIFTED MULTIMEDIA CONTENT

(76) Inventors: Manish W. Mahajan, Sunrise, FL (US); Daniel A. Baudino, Lake Worth, FL (US)

Correspondence Address: SMITH FROHWEIN TEMPEL GREENLEE BLAHA LLC, TWO RAVINIA DRIVE, SUITE 700, ATLANTA, GA, 30346, US

(21) Appl. No.: 11/616,042

(22) Filed: Dec. 26, 2006

(51) Int. Cl. H04N 7/10

(52) U.S. Cl. 725/34; 725/32

(57) ABSTRACT

A system (10), device (14) and method (70) for providing advertisement content in multimedia content based on the viewing location of the multimedia content, e.g., the viewing location of multimedia content place-shifted from a video processing device to a communication device. The method includes providing the viewing location of multimedia content received by a video processing device to an advertisement content provider, such as multimedia content place-shifted from the video processing device to a communication device, and transmitting new advertisement content from the advertisement content provider to the video processing device based on the viewing location of the multimedia content, e.g., the place-shifted multimedia content. The method also includes inserting the new advertisement content into the multimedia content based on the viewing location of the multimedia content. In this manner, the advertisement content in the multimedia content is better suited to the viewing location of the multimedia content.

### BACKGROUND OF THE INVENTION

1. Field of the Invention

The invention relates to replacing advertisement content in place-shifted multimedia content. More particularly, the invention relates to replacing advertisement content in place-shifted multimedia content based on characteristics of the place-shifted multimedia content.

2. Description of the Related Art

Video processing devices, such as video converter/decoder (set-top box) devices and other digital video recorder (DVR) devices, can be configured to have the ability to perform place shifting, which allows end users to watch multimedia programming content televised or received in one location from another location. Alternatively, a place shifting device can be connected to a conventional video processing device and to a broadband network to allow an end user to watch current multimedia content (e.g., live television broadcasts) or multimedia content stored in the video processing device from any location that has a connection to the broadband network.

The ability to place shift multimedia content has provided somewhat of a problem for providers of advertising content, especially providers of local advertising content, i.e., advertising content specific to the viewers of locally shown multimedia programming content. For DVR/set-top box end users or customers of systems based on Internet Protocol (IP) networks, advertising content providers typically use web-based unicasting models to provide more personalized or more target-specific advertising. Unicasting refers to streaming multimedia content from one node to another, e.g., in a IP-based network or web-based system. Unicasting is compared to more traditional multicasting models, which typically broadcast multimedia content from one node, e.g., a cable television content provider, to many downstream nodes, e.g., multiple cable television customers.

However, because of the ability of end users to place shift multimedia programming content, local advertising content becomes less effective. For example, a local advertisement inserted into a local program in one location (e.g., New York) is relatively ineffective for an end user located in another location (e.g., Florida) viewing the program via a place shifting device. Conventionally, targeted advertising methods and devices tailor and/or customize advertisement insertion into programming content based on various criteria, including end user preferences and demographics. However, conventional methods and devices have not involves place-shifted multimedia content and the viewers of place-shifted multimedia content.

### BRIEF DESCRIPTION OF THE DRAWINGS

FIG. 1 is a block diagram of a system for providing advertisement content in place-shifted multimedia content;

FIG. 2 is a block diagram of another system for providing advertisement content in place-shifted multimedia content;

FIG. 3 is a block diagram of a video processing device for use in a system for providing advertisement content in place-shifted multimedia content; and

FIG. 4 is a flow chart that schematically illustrates a method for providing advertisement content in place-shifted multimedia content.

### DETAILED DESCRIPTION

In the following description, like reference numerals indicate like components to enhance the understanding of the methods, systems and apparatus for providing advertisement content in place-shifted multimedia content through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

The methods, devices and systems described herein involve providing an advertisement server or advertisement content provider with information about the viewing location of multimedia content received by a video processing device, such as a set-top box. Based on the information about the viewing location of the multimedia content, the advertisement content provider can provide new advertisement content to the video processing device to insert into the multimedia content and/or replace existing advertisement content in the received multimedia content. In this manner, for example, multimedia content received by a video processing device in a first location and place-shifted to another device, such as a communication device, in a second location can include advertisement content that is customized or more local to the viewing location of the multimedia content, e.g., the location of the place-shifted communication device.

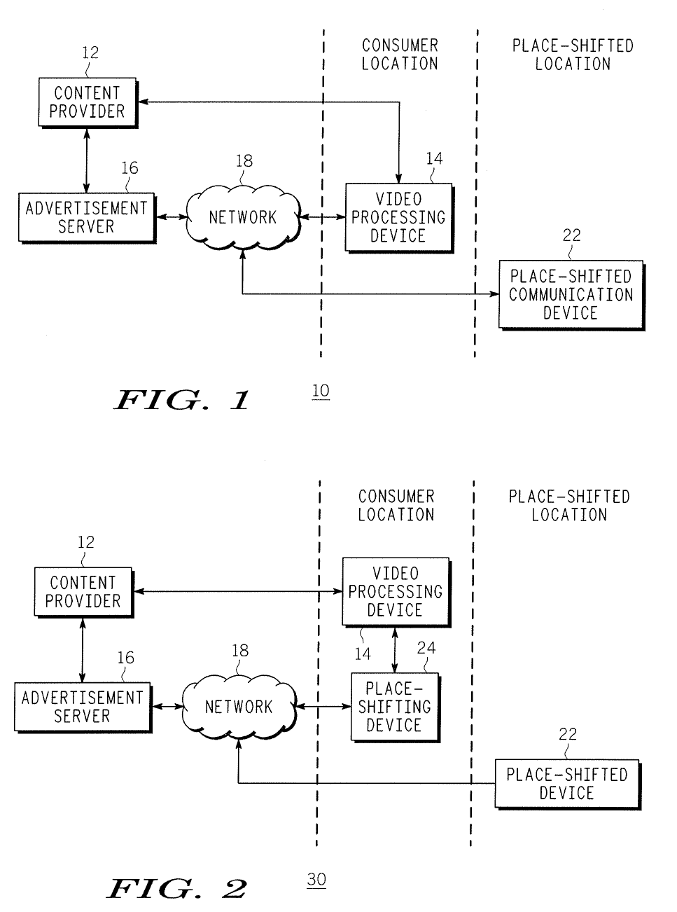

Referring now to FIG. 1, shown is a block diagram of a system 10 for providing advertisement content in place-shifted multimedia content. The system 10 includes a multimedia content provider 12, a video processing device 14 coupled to the multimedia content provider for receiving multimedia content, and an advertisement server or advertisement content provider 16 coupled to the multimedia content provider 12 for providing advertisement content to the multimedia content provider 12. The video processing device 14 and the advertisement content provider 16 can be coupled to one another via a network 18, such as an Internet protocol (IP) network. The system 10 also can include a place-shifted communication device 22 coupled to the network 18.

The content source 12 can be any suitable transmission source of multimedia content, such as over-the-air broadcasters, from a cable television plant, satellite service provider or other multimedia service provider. The multimedia content can be any suitable multimedia content, including movies, programming events, music, photos and/or other multimedia content that is distributed, e.g., as one or more programming streams from a broadcast source or other suitable multimedia content source. The multimedia content typically is a plurality of digital signals formatted according to a suitable standard, such as the MPEG (Moving Picture Experts Group) 2 or MPEG 4 standard, and multiplexed into a data stream that is modulated on a carrier using quadrature amplitude modulation (QAM) or other suitable modulation technique.

The content source 12 is connected to the video processing device 14 via any suitable connection, e.g., one or more coaxial cables and/or optical fibers, including a Hybrid Fiber Coaxial (HFC) cable system. Other suitable connections include suitable Fiber To The Premises (FTTP) systems, such as Fiber To The Curb (FTTC) or Fiber To The Home (FTTH), or over any suitable number of digital subscriber line systems (xDSL). Also, the multimedia content can be provided wirelessly, e.g., via over-the-air-broadcast from a satellite service provider or other suitable content service provider. As will be discussed in greater detail hereinbelow, some devices, such as home computers and computer-related devices, can receive multimedia content via a computer network, either through a wired connection or wirelessly. Other devices, such as mobile devices, including personal digital assistants (PDAs) and cellular telephones, can receive multimedia content wirelessly, via a wireless network.

The video processing device 14 can be any suitable device for receiving, viewing, processing and/or storing multimedia content. For example, the video processing device 14 can be any digital video recorder (DVR) or digital video server (DVS) device, including any signal converter or decoder (set-top) box with internal and/or external recording capabilities and local and/or remote storage, which often are referred to as personal video recorder (PVR) devices. Other suitable video processing devices include a residential gateway, a home media server system, a digital video disk recorder, a computer, a television with built-in or added-on multimedia content receiving and/or storing capability, or other suitable computing devices or video devices, including internet protocol (IP), satellite and cable digital video recorders, and home area network (HAN) devices and systems.

The advertisement server or advertisement content provider 16 can be any suitable device or system that can provide advertisement content to the content source 12 and/or the video processing device 14, e.g., directly or via the network 18. Conventionally, the insertion of advertisements or advertising programs into multimedia programming content is performed by either the broadcaster, the content service provider, and/or the local affiliate of the content service provider. Advertisement servers or advertisement content providers typically provide advertisements to the broadcasters and content service providers, for insertion into the multimedia content. In IP network or web-based systems, advertisement servers provide advertisement content to content service providers, such as a cable television station, via an IP network. In the system 10, the advertisement server 16 also can provide advertisement content to the video processing device 14, e.g., via the network 18.

The network 18 can be any communication network or network server arrangement suitable for coupling to the video processing device 14, the advertisement server 16 and the place-shifted communication device 22. For example the network 18 can be the Internet or an Internet protocol (IP) based network, a computer network, a web-based network or other suitable wired or wireless network system. Also, at least a portion of the network 18 can be any wired or wireless wide area network (WAN), local area network (LAN) or wireless local area network (WLAN), such as a residential network.

The communication device 22 can be any device suitable for place shifting multimedia content or receiving place-shifted multimedia content, e.g., from the video processing device 14. As discussed hereinabove, place shifting allows multimedia content received by a first device in a first location to be accessed by a second, place-shifted device in a second location. Place shifting involves forwarding multimedia content from a receiving device, such as the video processing device 14, to another device, such as the place-shifted communication device 22, via an Internet connection or other suitable network connection, such as the network 18. Place shifting also allows multimedia content stored in a first video processing device at a first location to be accessed or forwarded to a second communication device, e.g., in a second location.

For example, the communication device 22 can be any signal converter or decoder (set-top) box, including any DVR, DVS and/or PVR device, or any residential gateway or home media server system. Also, the communication device 22 can be any computer, television or display device with built-in or added-on multimedia content receiving capability, or other suitable computing devices or video devices, including internet protocol (IP), satellite and cable digital video recorders, and home area network (HAN) devices and systems. The communication device 22 also can be any suitable mobile communication device configured to receive multimedia content, such as a mobile or cellular telephone, a smartphone, a PDA or other wireless handheld device with such capability, a digital camera with such capability, a laptop personal computer (PC) or a notebook PC. The communication device 22 also can be in the form of a wired or wireless network and/or devices incorporated into or coupled to the network, e.g., via a wired connection or wirelessly.

The ability to place shift multimedia content directed to and/or received by the video processing device 14 can be located partially or completely within the video processing device 14, e.g., in the form of hardware and/or software modules and/or components. Also, the communication device 22 can include at least a portion of the modules and/or components used for place shifting multimedia content. Alternatively, the ability to perform place shifting can be provided by a separate device external to both the video processing device 14 and the communication device 22.

For example, referring now to FIG. 2, shown is a block diagram of another system 30 for providing advertisement content in place-shifted multimedia content. The arrangement of the system 30 is similar to the system 10 shown in FIG. 1 and described hereinabove, however, the system 30 includes a place shifting device 24 coupled to the video processing 14 and to the network 18. As shown, the place shifting device 24 is a separate component form the video processing device 14 and the communication device 22. In this arrangement, the place shifting device 24 can allow multimedia content received by the video processing device 14 to be place-shifted to the communication device 22 via the network 18.

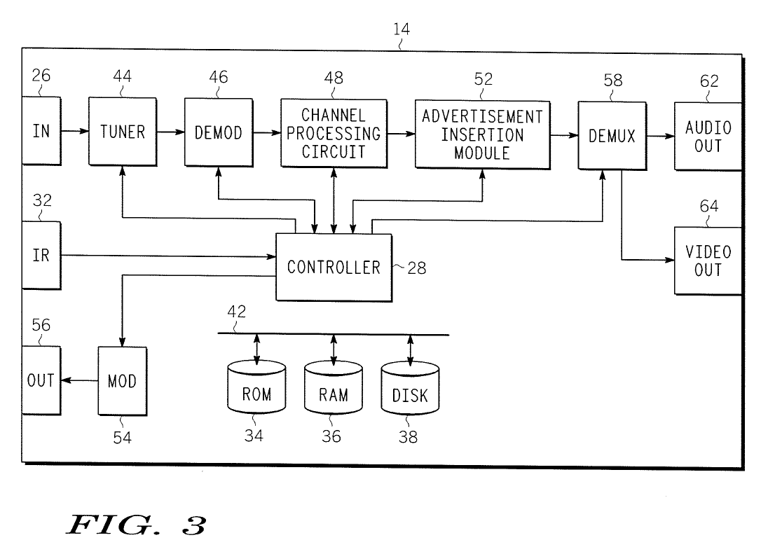

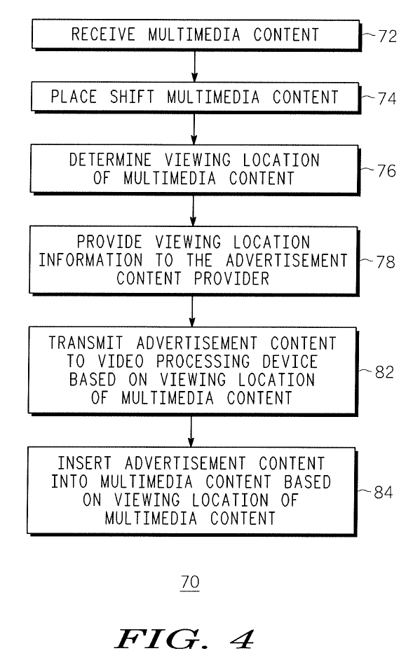

Referring now to FIG. 3, shown is a block diagram of a video processing device, such as the video processing device 14, for use in a system for providing advertisement content in place-shifted multimedia content. The video processing device 14 can be partially or completely any suitable device or subsystem (or portion thereof) for receiving multimedia content from a content source 12, processing or decoding the received multimedia content, and transmitting or transferring the processed multimedia content to an end user display device (not shown), such as a television, a computer monitor or other suitable display device. Although the display device typically is a separate component from the video processing device 14, it should be understood that the video processing device 14 and a display device can be combined or integrated as a single component.

The video processing device 14 an input port or interface 26 for receiving multimedia content, e.g., from the content provider 12. As discussed hereinabove, the multimedia content typically is a QAM-modulated MPEG2 or MPEG4 digital stream from the content provider 12. However, the multimedia content can be analog or digital content. If the multimedia content is analog, an MPEG encoder or other suitable encoder (not shown) typically would be included as part of the video processing device 14.

The video processing device 14 includes a controller or processing unit 28. In general, the controller 28 processes information received by the video processing device 14. The controller 28 can include at least one type of memory or memory unit (not shown) and a storage unit or data storage unit coupled to the processor for storing processing instructions and/or information received by the video processing device 14. The controller 28 can be central processing unit (CPU) that includes any digital processing device, such as a microprocessor, finite state machine (FSM), digital signal processor (DSP), application specific integrated circuit (ASIC) and/or general purpose computer. The controller 28 typically receives commands from the end user, such as through infrared (IR) reception of commands from a handheld remote control unit (not shown) through an IR receiving circuit 32. The controller 28 decodes the commands and forwards control signals to other circuits in the video processing device 14 to carry out the commands, such as changing the channel.

The video processing device 14 can include a read only memory (ROM) 34 containing software and fixed data used for operating the video processing device 14, and a random access memory (RAM) 36 for storing changeable data. The video processing device 14 also can include a separate internal or external large memory device, such as a hard disk drive or other storage element 38 for storing relatively large amounts of multimedia content, e.g., including advertisement content. Alternatively, the hard disk can be any suitable information storage unit, such as any suitable magnetic storage or optical storage device, including magnetic disk drives, magnetic disks, optical drives, optical disks, and memory devices, including flash memory. The controller 28, the ROM 34, the RAM 36 and the hard disk 38 are coupled to a master bus 42 over which the units can communicate with each other.

The input signal from input port 26 passes through a tuning circuit 44. Under control of the controller 28, the tuning circuit 44 selectively parses out the data corresponding to the particular channel selected by the viewer. The selected data is passed to a demodulator 46, which demodulates the data. A channel processing circuit 48 takes the demodulated channel data and processes it as needed. Such processing, which typically depends on the form of the input data and the particular features of the video processing device 14, can include decoding an encoded data stream. Also, as will be discussed in greater detail hereinbelow, the channel processing circuit 48 can be configured to determine the viewing location of multimedia content to be place-shifted from the video processing device 14 to another communication device, such as the place-shifted communication device 22.

The video processing device 14 also includes an advertisement insertion module 52 that inserts advertisement content into the multimedia content data stream passing from the channel processing circuit 48. As will be discussed in greater detail hereinbelow, the advertisement insertion module 52 inserts advertisement content into the multimedia content based on the viewing location of the multimedia content, e.g., if the multimedia content is to be or is being place-shifted to another device at another location.

Accordingly, the video processing device 14 also includes a modulator 54 coupled to the controller 28 for modulating data generated in the advertisement insertion module 52 and/or the controller 28 for transmission upstream. The modulator 54 is coupled to an output port or interface 56, which can be coupled to the network 18 or other appropriate place-shifting connection. It should be understood that the interface 26 and the interface 56 can be the same physical port, i.e., the interface 26 and the interface 56 can be a single input/output interface.

If the multimedia content received by the video processing device 14 is to be stored locally at the video processing device 14, the channel processing circuit 48 and/or the advertisement insertion module 52 can pass the multimedia content to one or more of the memory devices 36, 38 through the controller 28. The output of the advertisement insertion module 52 is coupled to a demultiplexor 58, which separates the audio and video portions of the multimedia content and forwards them to an audio output port or interface 62 and a video output port or interface 64, respectively. The audio output interface 62 and the video output interface 64 transfer the processed multimedia content, including stored multimedia content, to an end user display device (not shown), such as a television screen or a computer monitor.

One or more of the controller 28, the IR receiving circuit 32, the ROM 34, the RAM 36, the hard disk 38, the master bus 42, the tuner 44, the demodulator 46, the channel processing circuit 48, the advertisement insertion module 52, the modulator 54, the demultiplexor 58 and the interfaces 26, 32, 56, 62, 64 can be comprised partially or completely of any suitable structure or arrangement, e.g., one or more integrated circuits. Also, it should be understood that the video processing device 14 includes other components, hardware and software (not shown) that are used for the operation of other features and functions of the video processing device 14 not specifically described herein.

The video processing device 14 can be partially or completely configured in the form of hardware circuitry and/or other hardware components within a larger device or group of components. Alternatively, the video processing device 14 can be partially or completely configured in the form of software, e.g., as processing instructions and/or one or more sets of logic or computer code. In such configuration, the logic or processing instructions typically are stored in a data storage device, e.g., the ROM 34, the RAM 36 and/or the hard disk 38 or other suitable data storage device (not shown). The data storage device typically is coupled to a processor or controller, e.g., the controller 28, or other suitable processor or controller (not shown). The processor accesses the necessary instructions from the data storage device and executes the instructions or transfers the instructions to the appropriate location within the video processing device 14.

Referring now to FIG. 4, shown a flow chart that schematically illustrates a method 70 for providing advertisement content in place-shifted multimedia content. The method 70 includes a step 72 of receiving multimedia content, e.g., by the video processing device 14. The multimedia content, which typically is transmitted from an appropriate content source, e.g., the content source 12, typically is received by the video processing device 14 by the input interface 26, as discussed hereinabove.

The method 70 also includes a step 74 of place shifting at least a portion of the multimedia content received by the video processing device 14 to another communication device, such as the place-shifted communication device 22, e.g., via the network 18 or other suitable means. As discussed hereinabove, the video processing device 14, e.g., the channel processing circuitry 48 and/or other appropriate components, can be configured with the ability to place shift at least a portion of the multimedia content received by the video processing device 14. Alternatively, a separate place-shifting device, such as the place shifting device 24 shown in FIG. 2, can be coupled to the video processing device 14 for place-shifting at least a portion of the multimedia content received by the video processing device 14.

Regardless of the arrangement, as part of the place-shifting step 74, the multimedia content to be place shifted is made accessible by the place-shifting device, i.e., the video processing device 14 and/or the place-shifting device 24, to any appropriate communication device that can connect to the network 18. As such, the place-shifted communication device 22, via an appropriate connection to the network 18, with network privileges and using appropriate commands, can access the multimedia content received by the video processing device 14.

The method 70 also includes a step 76 of determining the viewing location of the multimedia content, e.g., if the multimedia content is place shifted to another communication device at a location other than the location of the video processing device 14. According to the step 76, the viewing location of the multimedia content can be determined by any suitable means. If the multimedia content is not place shifted to another communication device at another location, i.e., if the multimedia content is viewed by the video processing device 14, the viewing location of the multimedia content typically is or will be the location of video processing device 14. In such case, the viewing location of the multimedia content is readily determinable via conventional means.

However, if the multimedia content is place shifted to another communication device at another location, e.g., the place-shifted communication device 22, the determining step 76 can determine the location of the place-shifted communication device by other appropriate means. For example, the determination of the viewing location of the place-shifted communication device 22 can be performed by the video processing device 14 (and/or the place shifting device 24) and/or the place-shifted communication device 22. Also, the network 18 can provide information regarding the location of the place-shifted communication device 22. Moreover, other systems, such as global positioning systems (GPS) may be used to determine the location of the place-shifted communication device 22.

For example, if the place-shifted communication device 22 desires to place shift multimedia content received by the video processing device 14, the place-shifted communication device 22 accesses the multimedia content via the network 18. By appropriately connecting to the network 18 to access the multimedia content received by the video processing device 14, the place-shifted communication device 22 provides various information that can be used to determine the location of the place-shifted communication device 22, e.g., IP address information and/or network access point information. Such information can be used by one or more of the video processing device 14 and the network 18 to determine the location of the place-shifted communication device 22. Also, the place-shifted communication device 22 may include a GPS receiver or other appropriate hardware and/or software to provide location information for the place-shifted communication device 22.

If the place-shifted communication device 22 is a wireless device, such as a PDA or laptop PC, the wireless system within which the wireless device is operating can locate or provide location information with varying degrees of accuracy, depending on the wireless system and the actual location of the place-shifted communication device 22. Regardless of whether the place-shifted communication device 22 is connected to the network 18 wirelessly or via a wired connection, it should be understood that the retrieval of such location information can be initiated by one or more of the place-shifted communication device 22, the video processing device 14 and the network 18.

The method 70 includes a step 78 of providing the viewing location of the multimedia content, e.g., the place-shifted location of the place-shifted communication device 22, to the advertisement content provider 16. For example, the video processing device 14 can provide such location information to the advertisement content provider 16 via the network 18, as shown in the system arrangements of FIG. 1 and FIG. 2. Alternatively, the video processing device 14 can provide such information to the advertisement content provider 16 by other appropriate means, such as a wireless link or other wired network connection. Also, alternatively, if the network 18 has or has access to such location information, the network 18 can provide such information to the advertisement content provider 16, e.g., in response to such a request by the video processing device 14 and/or the place-shifted communication device 22.

The method 70 also includes a step 82 of the advertisement content provider 16 transmitting advertisement content to the video processing device 14 based on the viewing location of the multimedia content, e.g., based on the viewing location of the place-shifted communication device 22. As discussed hereinabove, the advertisement content provider 16 typically provides advertisement content to the content provider 12, e.g., the broadcaster, the content service provider and/or the local affiliate of the content service provider. The advertisement content provider 16 typically provides broadcasters with national or regional advertisement content. Content service providers typically receive national, regional and perhaps local advertisement content from the advertisement content provider 16. The advertisement content provider 16 typically provides local affiliates with local advertisement content, as well as some national and regional advertisement content.

According to the step 82, the advertisement content provider 16 provides a new set of advertisement content to the video processing device 14 based on the viewing location of the place-shifted communication device 22. For example, the new set of advertisement content can include local content that is more suitable for viewing in the viewing location of the place-shifted communication device 22 rather than the location of the video processing device 14. The advertisement content provider 16 can provide the new set of advertisement content to the video processing device 14 via the network 18 or via other appropriate means, e.g., a wireless link or other wired network connection.

For example, if the video processing device 14 is located in a particular area of New York, the initial or original set of advertisement content provided by the advertisement content provider 16 to the content provider 12 typically will contain some regional advertisement content that is particular to New York and some local advertisement content that is particular to the specific area of New York in which the video processing device 14 is located. Such advertisement content is inserted into the multimedia content streamed to the video processing device 14, typically by the content provider 12. However, if the place-shifted communication device 22 is located in a particular area of Florida and the multimedia content received by the video processing device 14 is place shifted to the place-shifted communication device 22, advertisement content particular to New York and various areas in New York tends to lose its advertising effectiveness if viewed in a different location, e.g., the particular area of Florida in which the place-shifted communication device 22 is located.

However, according to the step 82, the advertisement content provider 16 can provide the video processing device 14 with a new set of advertisement content that is based on the place-shifted location of the place-shifted communication device 22. Thus, for example, the new set of advertisement content typically will include more regional advertisement content that is particular to Florida, instead of New York, and more local advertisement content that is particular to the particular area of Florida in which the place-shifted communication device 22 is located. In this manner, the new set of advertisement content is more relevant to the viewing location of the place-shifted communication device 22, and thus will be more effective advertisement content.

The method 70 also includes a step 84 of the video processing device 14 inserting advertisement content into the multimedia content based on the viewing location of the multimedia content, e.g., the place-shifted viewing location of the place-shifted communication device 22. For example, the video processing device 14, via its advertisement insertion module 52, can insert at least a portion of the new set of advertisement content into the multimedia content that is to be place shifted to the place-shifted communication device 22. The portion of the new set of advertisement content inserted into the multimedia content being place shifted can replace all or a portion of the national, regional and/or local advertisement content in the multimedia content received by the video processing device 14.

The new set of advertisement content can include therewith or have embedded therein insertion instructions, e.g., in a format that can be read by the video processing device 14, such as by the controller 28 and/or other suitable component within the video processing device 14. For example, the insertion instructions can be encoded or embedded in the new advertisement content as metadata. The video processing device 14 is configured to read such insertion instructions and insert advertisement content into the multimedia content accordingly.

Moreover, according to the step 84, in addition to inserting new advertisement content into the multimedia content being place shifted based on the viewing location of the multimedia content, e.g., the location of the place-shifted communication device, additional criteria can be used to guide the insertion of new advertisement content. For example, new advertisement content can be inserted in multimedia content being place shifted further based on the time of viewing of the place-shifted multimedia content, any time-based content in the new advertisement content and/or any time-based content in the multimedia content being place shifted. Such information also can be encoded or embedded, e.g., as metadata, into the new advertisement content.

The method shown in FIG. 4 may be implemented in a general, multi-purpose or single purpose processor. Such a processor will execute instructions, either at the assembly, compiled or machine-level, to perform that process. Those instructions can be written by one of ordinary skill in the art following the description of FIG. 4 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the methods, systems and apparatus for providing advertisement content in place-shifted multimedia content herein described without departing from the spirit and scope of the invention as defined by the appended claims and their full scope of equivalents.

1. A method for providing advertisement content for multimedia content, comprising the steps of:
receiving multimedia content by a video processing device;
providing to an advertisement server a viewing location of the multimedia content received by the video processing device;
transmitting by the advertisement server advertisement content to the video processing device based on the viewing location of the multimedia content received by the video processing device; and
inserting by the video processing device advertisement content into at least a portion of the multimedia content being received by the video processing device based on the viewing location of the multimedia content received by the video processing device.

2. The method as recited in claim 1, wherein the video processing device is located in a first location, and wherein the received multimedia content is place shifted to a communication device at a second location for viewing by an end user, wherein the second location is a different location than the first location.

3. The method as recited in claim 1, wherein the inserting step replaces existing advertisement content in the multimedia content with advertisement content based on the viewing location of the multimedia content received by the video processing device.

4. The method as recited in claim 1, wherein the inserting step inserts advertisement content into the multimedia content based on at least one of the time of viewing the multimedia content, time-based content in the advertisement content and time-based content in the multimedia content.

5. The method as recited in claim 1, further comprising the step of determining the viewing location of the multimedia content received by the video processing device.

6. The method as recited in claim 5, wherein the determining step determines the viewing location of the multimedia content received by the video processing device using a global positioning system (GPS).

7. The method as recited in claim 1, wherein the determining step determines the viewing location of the multimedia content received by the video processing device using the Internet Protocol (IP) address information of the device viewing the multimedia content.

8. A video processing device, comprising:
a controller configured to receive multimedia content from a multimedia content provider;
a memory element coupled to the controller for storing at least a portion of the multimedia content received by the controller; and
an advertisement insertion module coupled to the controller,
wherein at least one of the controller and the advertisement insertion module is configured to determine the viewing location of the multimedia content received by the video processing,
wherein the controller is configured to transmit to an advertisement content provider coupled to the video processing device information related to the viewing location of the multimedia content received by the video processing device,
wherein the video processing device is configured to receive advertisement content from the advertisement content provider based on the viewing location of the multimedia content received by the video processing device, and
wherein the advertisement insertion module is configured to insert advertisement content provided by the advertisement content provider into at least a portion of the multimedia content received by the video processing device based on the viewing location of the multimedia content received by the video processing device.

9. The device as recited in claim 8, wherein the video processing device is located in a first location, and wherein the received multimedia content is place shifted to a communication device at a second location for viewing by an end user, wherein the second location is a different location than the first location.

10. The device as recited in claim 9, wherein at least one of the controller and the advertisement insertion module is configured to determine the viewing location of the multimedia content received by the video processing device based on information related to the Internet Protocol (IP) address of the communication device.

11. The device as recited in claim 8, wherein the advertisement insertion module is configured to replace existing advertisement content in the multimedia content received by the video processing with advertisement content provided by the advertisement content provider based on the viewing location of the multimedia content received by the video processing device.

12. The device as recited in claim 8, wherein the video processing device is configured to determine the viewing location of the multimedia content received by the video processing device using a global positioning system (GPS).

13. The device as recited in claim 8, wherein the video processing device is coupled to the advertisement content provider via at least one of an Internet Protocol (IP) network connection, a wireless link and a wired network connection.

14. The device as recited in claim 8, wherein the video processing device is selected from the group consisting of a signal converter box, a signal decoder box, a digital video recorder, a digital video disk recorder, a personal video recorder device, a home media server, a digital video server, a residential gateway, a video receiver, a computer and a place-shifting device.

15. The device as recited in claim 8, wherein the communication device is selected from the group consisting of a signal converter box, a signal decoder box, a digital video recorder, a digital video disk recorder, a personal video recorder device, a set-top box, a home media server, a digital video server, a residential gateway, a video receiver, a personal digital assistant (PDA) device, a cellular telephone, a smartphone, a wireless handheld device, a mobile communication device, a digital camera, a desktop personal computer (PC), a laptop PC and a notebook PC.

16. A system for providing advertisement content for multimedia content, comprising:
a video processing device configured to receive multimedia content from a multimedia content provider;
a communication device configured to receive place-shifted multimedia content; and
a place-shifting device coupled to the video processing device and the communication device, wherein the place-shifting device is configured to place shift multimedia content received by the video processing device to the communication device,
wherein at least one of video processing device, the communication device and the place shifting device is configured to provide the viewing location of the multimedia content received by the video processing device to an advertisement content provider coupled to the video processing device,
wherein the advertisement content provider is configured to provide advertisement content to the video processing device based on the viewing location of the multimedia content received by the video processing device, and
wherein the video processing device is configured to insert advertisement content into at least a portion of the multimedia content received by the video processing device based on the viewing location of the multimedia content received by the video processing device.

17. The system as recited in claim 16, wherein at least a portion of the place-shifting device is contained within at least one of the video processing device and the communication device.

18. The system as recited in claim 16, wherein the video processing device includes an advertisement insertion module configured to insert advertisement content into at least a portion of the multimedia content received by the video processing device based on the location of the communication device.

19. The system as recited in claim 16, wherein the video processing device is coupled to at least one of the communication device, the place shifting device and the advertisement content provider via at least one of an Internet Protocol (IP) network connection, a wireless link and a wired network connection.
